(19) United States
(12) Patent Application Publication
(10) Pub. No.: US 2007/0121557 A1
(43) Pub. Date: May 31, 2007

(54) Location broadcasting

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/289,183

(22) Filed: Nov. 29, 2005

(51) Int. Cl. H04Q 7/24

(52) U.S. Cl. 370/338

(57) ABSTRACT

The present invention broadcasts location information to communication terminals, which are located in a geographic area associated with the location information. Communication terminals within the area in which the broadcasted location information can be received will receive the location information and be able to use the location information as an indication of their actual locations. As such, the communication terminals can determine their locations based on the broadcasted information. The location information may be manually provisioned in the broadcasting devices. Alternatively, the location information can be obtained from another source or a location system, such as a GPS receiver.

### FIELD OF THE INVENTION

The present invention relates to communications and in particular to broadcasting location information to communication terminals.

### BACKGROUND OF THE INVENTION

There are many applications in which communication terminals can take advantage of location information, which bears on the geographic location of the communication terminal. The location information can be used to alert users or others of the user's relative location, track where the users have traveled, and provide directions to a desired destination. The communication terminals can also use the location information to update time information base on the current time zone. Other applications may use location information to provide a location stamp identifying a relative location where a file or document was created or modified. Further, communication terminals with camera functionality can use the location information to identify where a picture was taken.

Location information can also be used to assist with communications. Presence systems rely on various types of information, including a user's location or the location of the user's communication terminal, to determine the user's relative availability to engage in communications, what type of communications are appropriate, and how to route communications to the user. In many instances, the user's location is a key factor in determining when and how to communicate with the user.

In wireless communication environments, the location of the communication terminal can be used to control handoffs from base station to base station in cellular systems and from access point to access point in local wireless systems, such as those employing wireless local area network (WLAN) technologies. Future communication terminals will be able to support both cellular and local wireless communications and location information will also be useful in determining when to switch between cellular and local wireless modes of operation.

To obtain location information, communication terminals have traditionally relied on integrated Global Positioning System (GPS) receivers or accessing a communication network to retrieve location information generated specifically for the communication terminal based on triangulation techniques. Providing integrated GPS receivers in a communication terminal is expensive, and triangulation techniques are complicated and burdensome to the supporting networks. Given the wide ranging applications that take advantage of location information, there is a need for a cost effective and efficient technique for providing to communication terminals location information bearing on the geographic locations of the communication terminals.

### SUMMARY OF THE INVENTION

The present invention broadcasts location information to communication terminals, which are located in a geographic area associated with the location information. Communication terminals within the area in which the broadcasted location information can be received will receive the location information and be able to use the location information as an indication of their actual locations. As such, the communication terminals can determine their locations based on the broadcasted information. The location information may be manually provisioned in the broadcasting devices. Alternatively, the location information can be obtained from another source or a location system, such as a GPS receiver.

The location information can be broadcast to communications terminals that are currently in the area associated with the location information in several ways. A wireless device can broadcast the location information such that communication terminals within range of the wireless device can receive the location information. The communication range of the wireless device will correspond to the area associated with the location information. The wireless device could be a standalone device or a wireless access point. Alternatively, a local area network (LAN) device can broadcast the location information over a particular network or portions of the network corresponding to the area associated with the location information. The LAN device could be a standalone device, hub, switch, router, or gateway residing on the network or portion of the network.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a communication environment according to one embodiment of the present invention.

FIG. 2 illustrates beacon transmissions according to one embodiment of the present invention.

FIG. 3 is a block representation of a frame format including location information according to one embodiment of the present invention.

FIG. 4 is a block representation of a wireless access point according to one embodiment of the present invention.

FIG. 5 is a block representation of an Ethernet hub according to one embodiment of the present invention.

FIG. 6 is a block representation of a location node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a mechanism to broadcast geographic location information to communication terminals that are located in an area associated with the geographic location information. The location information may be broadcast using wired or wireless communication techniques to any or all of a number of communication terminals located in the area. The broadcasting of the location information may be limited to communication terminals within or substantially proximate to the area associated with the geographic location information to avoid having the location information received by communication terminals that are outside of the area.

The location information may take various forms. The location information may simply be an exact location of the broadcasting device, coordinates or a location reference of the broadcasting device, or coordinates or a location reference of the area in which the broadcasted location information can be received. Regardless of the broadcasting mechanism, the location information is directly or indirectly associated with the geographic area in which the location information can be received.

The location information can be broadcast to communication terminals in the area associated with the location information in several ways. For example, a wireless device can broadcast the location information such that communication terminals within range of the wireless device can receive the location information. The communication range of the wireless device will correspond to the area associated with the location information. The wireless device could be a standalone device or a wireless access point. Alternatively, a local area network (LAN) device can broadcast the location information over a particular network or portions of the network corresponding to the area associated with the location information. The LAN device could be a standalone device, hub, switch, router, or gateway residing on the network or portion of the network.

The location information may be manually provisioned in the broadcasting devices. Alternatively, the location information can be obtained from another source or a location system, such as a Global Positioning System (GPS) receiver. Further details are provided after an overview of a communication environment in which various mechanisms are capable of broadcasting the location information.

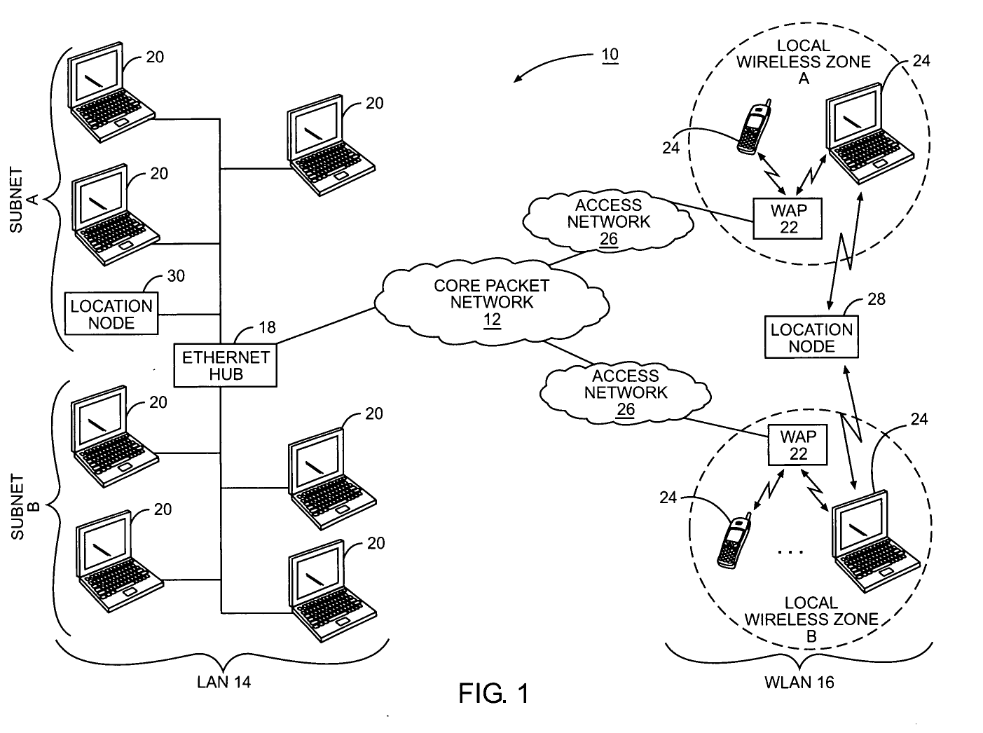

With reference to FIG. 1, a communication environment 10 is illustrated. At the center of the communication network 10 resides a core packet network 12 to which both a local area network (LAN) 14 and a wireless local area network (WLAN) 16 are directly or indirectly connected. The LAN 14 is connected to the core packet network 12 through what is generically referred to as an Ethernet hub 18, which may take the form of a traditional network hub, router, switch, or gateway. Various communication terminals 20 are connected to the Ethernet hub 18 to form the LAN 14. The LAN 14 may be broken into various subnets, represented as subnet A and subnet B. The LAN 14 may be associated with a given area. Further, subnet A and subnet B may also be associated with areas within the larger area associated with the LAN 14.

Accordingly, the Ethernet hub 18 may be able to broadcast location information associated with the area corresponding to the LAN 14 to all of the communication terminals 20 residing on the LAN 14. The Ethernet hub 18 may also be configured to broadcast location information corresponding to an area associated with subnet A to only those communication terminals 20 associated with subnet A. Similarly, the Ethernet hub 18 may be able to send location information associated with the area for subnet B to only the communication terminals 20 associated with subnet B. Once the communication terminals 20 are connected to the LAN 14 or their respective subnets, the location information received from the Ethernet hub 18 can be used for various functions. Regardless of use, the location information will bear on a defined area and will be broadcast on a systematic basis, such that multiple ones of the communication terminals 20 can receive the location information at any given time.

For the WLAN 16, different wireless access points (WAPs) 22 support local wireless communications over a limited range. This limited range correlates to a local wireless zone, and as illustrated, local wireless zones A and B are formed by the two wireless access points 22. The local wireless communications may use various WLAN technologies, including those set forth in the IEEE's 802.11 standards, as well as Wi-Fi or Bluetooth standards. The wireless access points 22 facilitate local wireless communications with any number of communication terminals 24, which may represent various types of mobile terminals, including mobile telephones, personal digital assistants, personal computers, or other wireless communication devices. The wireless access points 22 are connected directly or indirectly to the core packet network 12 via an appropriate access network 26.

In operation, the wireless access points 22 will systematically broadcast location information such that any communication terminals 24 within the corresponding local wireless zone A or B will receive the location information. From the location information, the relative geographic location of the mobile terminal 24 can be determined by the mobile terminal 24 itself or by other entities that may be able to use the local wireless zone information to determine the relative geographic location of the mobile terminal 24. For the WLAN 16, the location information will relate to an area corresponding to the local wireless zone in which the location information was received. Each of the wireless access points 22 may send the same location information, which would bear on the relative coverage area associated with the WLAN 16. Alternatively, each wireless access point 22 may send different location information, bearing on the area corresponding to each local wireless zone A and B. Depending on the configuration of the location information, the communication terminals 24 or associated entities using the location information will be able to determine that the communication terminal 24 is within an area covered by the WLAN 16 and perhaps areas corresponding to the respective local wireless zones A and B. Thus, different levels of resolution can be provided depending on how broadcasting of the location information is configured.

In addition to broadcasting location information from the wireless access points 22 or the Ethernet hub 18, location nodes 28 and 30 may be used as standalone devices to broadcast location information corresponding to their relative areas of coverage or connectivity. In the case of location node 28, location information may be provided corresponding to the relative communication range associated with location node 28. The location information provided by location node 30, which resides on the LAN 14, may be provided in the same manner as that provided by the Ethernet hub 18, wherein location information may be provided for the entire LAN 14, or defined subnets A and B.

The location information may be broadcast in transmissions dedicated to sending the location information, or may be integrated into existing broadcast messages. For example, wireless access points 22 will routinely send beacon frames throughout the associated local wireless zones, wherein any communication terminals 24 within the local wireless zone will receive the beacon transmissions. Beacon transmissions may be used to identify the presence of the wireless access point 22 to those communication terminals 24 within communication range. Various types of information can be provided in the beacon transmissions, and the beacon transmissions may be configured to assist in allowing the communication terminals 24 to understand channel conditions between the wireless access point 22 and the communication terminal 24. In one embodiment of the present invention, the location information is provided within a dedicated field of beacon frame transmission.

The location information may take many forms, including geolocation coordinates (longitude, latitude, altitude), civic address (street, city, etc.), descriptive text (Baseball stadium) or any combinations thereof. The location information itself may not be static. If for example the wireless access point 22 is located on a plane, train, or boat, the navigation equipment of these may be used to provide up to the minute updates of the current location of the vehicle, making it then available to the communication terminals 24.

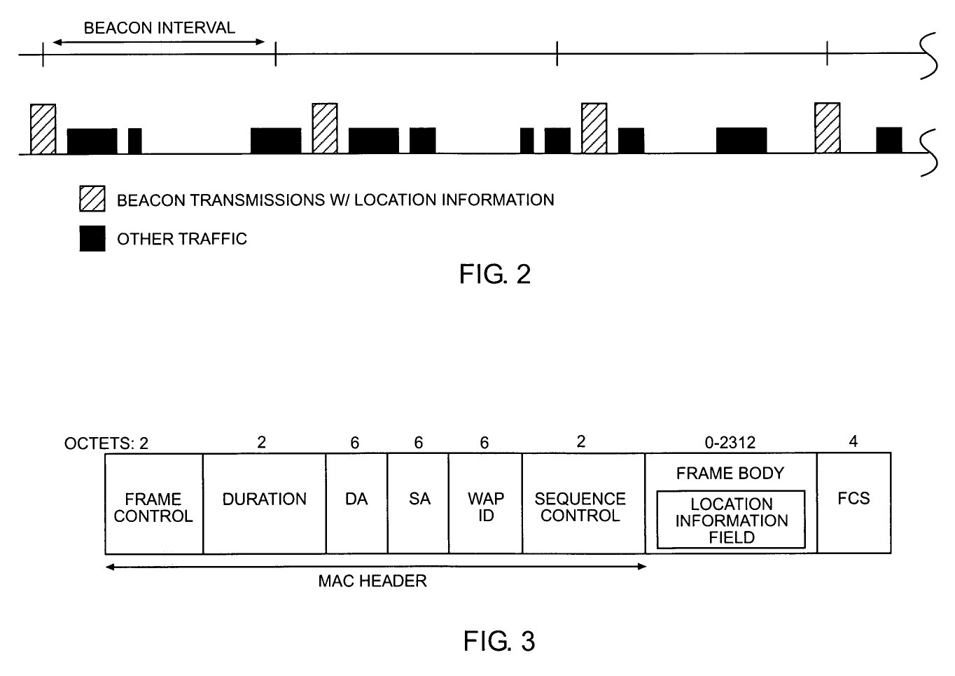

With reference to FIG. 2, the diagram illustrates beacon transmissions being broadcast within each beacon interval. The beacon transmissions are provided at periodic intervals by the wireless access point 22. Since each beacon transmission is sent at periodic intervals, the communication terminals 24 can systematically scan for a beacon transmission in an effort to receive beacon transmissions.

An example beacon transmission is illustrated in FIG. 3, wherein a management frame format is provided. The management frame may take many forms, including that of a beacon transmission. The first six fields correspond to the MAC header, and include a 2-octet frame control field for defining the type of frame. The frame control field may provide information identifying the frame as a beacon frame, identifying the frame as including the location information, or a combination thereof. Again, the location information can be sent in different types of frames that are not beacon transmissions. The second field is a 2-octet duration field identifying the length of the frame. The next to fields are 6-octet fields for the destination address (DA) and the source address (SA) for the frame. The following 6-octet field may include an identification (ID) for the wireless access point 22 from which the frame is broadcast. The last field in the MAC header is a 2-octet sequence control field, which may be used to keep different portions of the frame in sequence, if the frame is broken up during transmission. Following the MAC header is a frame body, the length of which is shown to be somewhere between zero and 2312 octets. The frame body may include any type of information, including the location information, which is shown provided in a location information field within the frame body. The last field is a 4-octet blank checksum (FCS) field. Those skilled in the art will recognize that the location information may be broadcast in various types of networks in different manners. The location information may be provided in dedicated broadcasts, or may be integrated into broadcasts of other information. Regardless of the manner in which location information is broadcast, the location information will correspond to a geographic area in which the broadcast can be received.

The device that broadcasts the location information to either the communication terminals 20 or communication terminals 24 may obtain the location information in one or more of the following ways. Those skilled in the art may recognize additional techniques for arming the broadcasting device with the corresponding location information. The location may be received manually or via another network entity. Further, location detection mechanisms may be employed to provide the location information, or information from which the location information may be derived. For example, a GPS receiver may be used to determine the location information for a given one of the devices that is capable of broadcasting the location information to the communication terminals 20 or 24. The following provide more detailed descriptions of a wireless access point 22, an Ethernet hub 18, and a location node 28.

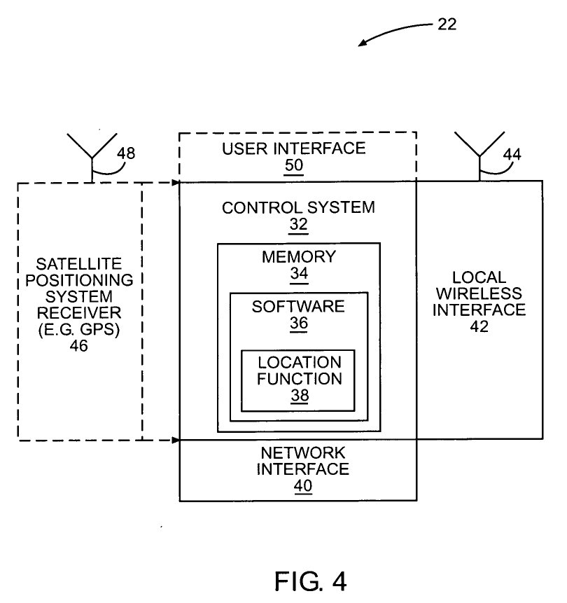

With reference to FIG. 4, a block representation of a wireless access point 22 is provided. The wireless access point 22 will include a control system 32 having sufficient memory 34 for the software 36 to facilitate operation as described above. In particular, a location function 38 is provided to determine or otherwise create the location information to be broadcast, and then control broadcasting of the location information to the communication terminals 24 that are within a corresponding local wireless zone. The control system 32 will also be associated with a network interface 40 to provide a direct or indirect connection to a corresponding access network 26. The control system 32 will also be associated with a local wireless interface 42 and a corresponding antenna 44 to facilitate local wireless communications with the communication terminals 24 that are within the local wireless zone associated with the wireless access point 22.

The location information to be broadcast throughout the local wireless zone may be received from another network device, as well as via an associated satellite positioning system receiver 46 and corresponding antenna 48. The satellite positioning system receiver 46 may be a GPS receiver, which is integrated into the wireless access point 22 or permanently or temporarily connected to the wireless access point 22. The control system 32 will cooperate with the satellite positioning system receiver 46 to enable the relative location of the wireless access point 22 to be determined. From this information, the location information is generated for broadcast throughout the local wireless zone. The control system 32 may also be associated with a user interface 50 through which the location information may be manually provisioned or broadcast throughout the local wireless zone.

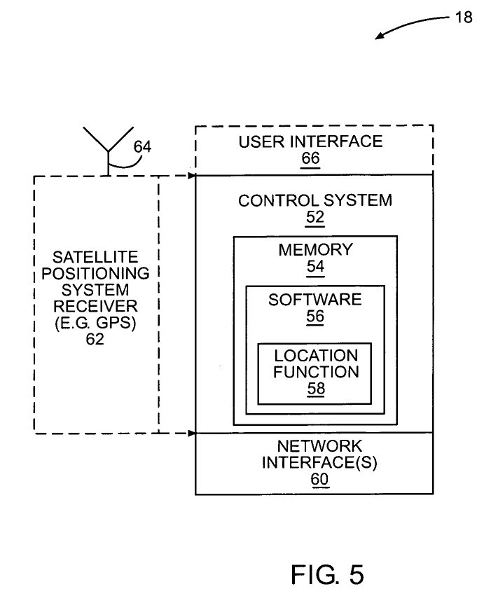

With reference to FIG. 5, an Ethernet hub 18 is illustrated. The Ethernet hub 18 will have a similar configuration to that of the wireless access point 22, with the exception of the local wireless interface 42. As such, the Ethernet hub 18 may include a control system 52 having sufficient memory 54 for the requisite software 56 to operate as described above, and a location function 58. The control system 52 will be associated with one or more network interfaces 60 to facilitate communications with the communication terminals 20, as well as directly or indirectly with the core packet network 12. The control system 52 may be configured with the ability to broadcast information over the entire LAN 14, or to communication terminals 20 in specific subnets, as described above. This operation will be controlled by the location function 58, which will manage the location information and control broadcast of the location information as desired.

As with the wireless access point 22, the Ethernet hub 18 may have an integrated satellite positioning system receiver 62 or may temporarily or permanently be associated with one. The satellite positioning system receiver 62 will be associated with the requisite antenna 64 to receive the satellite positioning signals, such as the GPS signals used in GPS receivers. The control system 52 may also be associated with a user interface 66, if manual provisioning or other manual configuration is desired. As indicated above, the Ethernet hub 18 is a generic device residing on the LAN 14, and may take the form of a traditional hub, switch, router, or gateway.

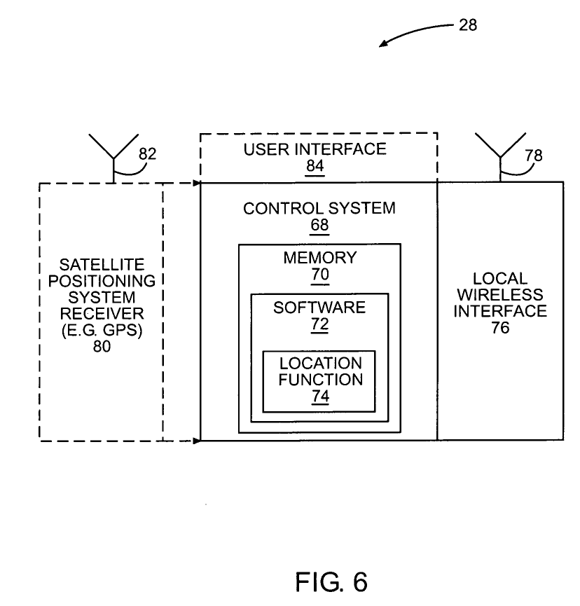

Turning now to FIG. 6, an exemplary location node 28 is provided. The location node 28 is configured similarly to the wireless access point 22, but may not provide the routing and forwarding of communication packets between the access network 26 and the participating communication terminals 24. Instead, the location node 28 will primarily function to broadcast the location information to communication terminals 24 that are within a given communication range, which is again referred to as a local wireless zone. Accordingly, the location node 28 will have a control system 68 with sufficient memory 70 for the requisite software 72 to operate as described above. The software 72 may provide a location function 74 to control the broadcasting of the location information via a local wireless interface 76 and associated antenna 78. Again, a satellite positioning system receiver 80 and associated antenna 82 may be integrated with the location node 28, or permanently or temporarily associated therewith in order to provide sufficient information from which the location information to be broadcast may be derived. Alternatively, a user interface 84 may be associated with the control system 68 through which the location information can be manually provisioned. Although not specifically illustrated, the location node 30 will have a similar configuration to that of location node 28, with the exception that the local wireless interface 76 will be replaced with one or more network interfaces for facilitating communications over the LAN 14.

Those skilled in the art will recognize improvements and modifications to the preferred embodiments of the present invention. All such improvements and modifications are considered within the scope of the concepts disclosed herein and the claims that follow.

What is claimed is:

1. A method comprising:
obtaining location information associated with a geographic area; and
broadcasting the location information for reception by any communication terminals within the geographic area.

2. The method of claim 1 wherein the location information is broadcast via local wireless communications throughout a local wireless zone.

3. The method of claim 2 wherein the location information is broadcast from a wireless access point.

4. The method of claim 1 wherein the location information is broadcast via Ethernet-based communications throughout a local area network.

5. The method of claim 4 wherein the location information is broadcast from an Ethernet hub.

6. The method of claim 1 wherein the location information is broadcast via Ethernet-based communications throughout a subnet of a local area network.

7. The method of claim 1 wherein the location information is broadcast in a beacon transmission.

8. The method of claim 7 wherein the beacon transmission comprises information identifying a wireless access point from which the beacon transmission is transmitted.

9. The method of claim 1 wherein the location information is broadcast from a broadcasting device and identifies a geographic location of the broadcasting device.

10. The method of claim 1 wherein the location information identifies the geographic area in which the location information can be received when broadcast.

11. The method of claim 1 further comprising:
receiving satellite positioning indicia bearing on a position of a satellite positioning receiver, which is associated with a broadcasting device; and
creating the location information based on the satellite positioning indicia.

12. The method of claim 1 wherein the location information is dynamic.

13. The method of claim 1 wherein the location information comprises one of the group consisting of geolocation coordinates, civic address, and descriptive text for a location.

14. A system comprising:
a communication interface; and
a control system associated with the communication interface and adapted to:
obtain location information associated with a geographic area and
broadcast the location information for reception by any communication terminals within the geographic area.

15. The system of claim 14 wherein the communication interface is a wireless communication interface and the location information is broadcast via local wireless communications throughout a local wireless zone.

16. The system of claim 15 further comprising a network interface associated with the control system, and wherein system is a wireless access point.

17. The system of claim 14 wherein the communication interface is a network interface and the location information is broadcast via Ethernet-based communications throughout a local area network.

18. The system of claim 14 wherein the system is an Ethernet hub.

19. The system of claim 14 wherein the location information is broadcast via Ethernet-based communications throughout a subnet of a local area network.

20. The system of claim 14 wherein the location information is broadcast in a beacon transmission.

21. The system of claim 20 wherein the beacon transmission comprises information identifying a wireless access point from which the beacon transmission is transmitted.

22. The system of claim 14 wherein the location information identifies a geographic location of the system.

23. The system of claim 14 wherein the location information identifies the geographic area in which the location information can be received when broadcast.

24. The system of claim 14 further comprising a satellite positioning receiver adapted to provide to the control system with satellite positioning indicia bearing on a position of the satellite positioning receiver, the control system further adapted to create the location information based on the satellite positioning indicia.

25. The system of claim 14 wherein the location information is dynamic.

26. The system of claim 14 wherein the location information comprises one of the group consisting of geolocation coordinates, civic address, and descriptive text for a location.
